(19) United States
(12) Patent Application Publication
(10) Pub. No.: US 2020/0222999 A1
(43) Pub. Date: Jul. 16, 2020

(54) ROTATING CUTTING ASSEMBLY AND CUTTING TOOTH FOR A ROTATING CUTTING ASSEMBLY

(71) Applicant: Vermeer Manufacturing Company, Pella, IA (US)

(72) Inventor: James Lee Curry, JR., Memphis, MO (US)

(21) Appl. No.: 16/682,238

(22) Filed: Nov. 13, 2019

Related U.S. Application Data
(60) Provisional application No. 62/790,530, filed on Jan. 10, 2019.

(51) Int. Cl. B23D 61/06; B23D 61/02

(52) U.S. Cl. CPC B23D 61/06; B23D 61/021

(57) ABSTRACT

A rotating cutting assembly includes a wheel and a tooth base coupled to an outer periphery of the wheel. The tooth base includes a narrowed stem and an aperture spaced from the narrowed stem. The cutting assembly further includes a cutting tooth removably secured to the tooth base. The cutting tooth has a mounting surface configured to engage the tooth base, and first and second bosses extending from the mounting surface and spaced apart from one another by a distance at least as large as a width of the narrowed stem such that the first and second bosses straddle the stem when the mounting surface engages the tooth base. The cutting tooth further includes an aperture aligned with the aperture in the tooth base. A fastener is received in the aperture of the cutting tooth and the aperture of the base to removably secure the cutting tooth to the base.

### RELATED APPLICATIONS

This application claims the benefit of U.S. Provisional Patent Application No. 62/790,530 filed Jan. 10, 2019, the entire content of which is hereby incorporated by reference herein.

### BACKGROUND

The present invention relates to rotating cutting assemblies, and to cutting teeth for use on rotating cutting assemblies.

### SUMMARY

In one aspect, the invention provides a rotating cutting assembly having a wheel and a tooth base coupled to an outer periphery of the wheel. The tooth base includes a narrowed stem and an aperture spaced from the narrowed stem. The cutting assembly further includes a cutting tooth removably secured to the tooth base. The cutting tooth has a mounting surface configured to engage the tooth base, and first and second bosses extending from the mounting surface and spaced apart from one another by a distance at least as large as a width of the narrowed stem such that the first and second bosses straddle the stem when the mounting surface engages the tooth base. The cutting tooth further includes an aperture aligned with the aperture in the tooth base. A fastener is received in the aperture of the cutting tooth and the aperture of the tooth base to removably secure the cutting tooth to the tooth base.

In another aspect, the invention provides a cutting tooth configured to be mounted on a rotating apparatus. The cutting tooth includes a body having a mounting surface configured to engage the rotating apparatus, first and second bosses extending from the mounting surface and spaced apart from one another such that a portion of the rotating apparatus can be positioned between the first and second bosses when the mounting surface engages the rotating apparatus, and an aperture configured to receive a fastener for removably securing the cutting tooth to the rotating apparatus. A cutting tip is coupled to the body.

In yet another aspect, the invention provides a rotating cutting assembly including a wheel and a tooth base coupled to an outer periphery of the wheel. The tooth base includes a narrowed portion having an upper surface, spaced-apart side walls extending from the upper surface, and an aperture spaced from the narrowed portion. A cutting tooth is removably secured to the tooth base and has a mounting surface configured to engage the upper surface of the tooth base, and first and second bosses extending from the mounting surface and spaced apart from one another such that respective inner surfaces of the first and second bosses engage the respective side walls of the narrowed portion when the mounting surface engages the upper surface. The cutting tooth further includes an aperture aligned with the aperture in the tooth base. A fastener is received in the aperture of the cutting tooth and the aperture of the tooth base to removably secure the cutting tooth to the tooth base. The fastener includes an axis generally perpendicular to a dominant force vector at a cutting tip of the cutting tooth as the cutting assembly cuts through a material. The mounting surface defines a plane that is generally parallel to the dominant force vector at the cutting tip. The inner surfaces of the first and second bosses are generally parallel to one another and generally perpendicular to the mounting surface.

Other aspects of the invention will become apparent by consideration of the detailed description and accompanying drawings.

### BRIEF DESCRIPTION OF THE DRAWINGS

FIG. 1 is a side view illustrating a vehicle towing a trenching device having a cutting wheel according to the present invention.

FIG. 2 is a side view of the cutting wheel of FIG. 1.

FIG. 3 is an enlarged partial side view of the cutting wheel of FIG. 2.

FIG. 4 is a partial exploded perspective view of the cutting wheel of FIG. 2.

FIG. 5 is a partial side view of the cutting wheel of FIG. 2, showing only the wheel prior to installation of the tooth bases and the cutting teeth.

FIG. 6 is a perspective view of a tooth base.

FIG. 7 is a top view of the tooth base of FIG. 6.

FIG. 8 is a perspective view of the cutting tooth.

FIG. 9 is a front view of the cutting tooth of FIG. 8.

FIG. 10 is a side view of the cutting tooth of FIG. 8

FIG. 11 is a bottom view of a cutting tooth of FIG. 8.

FIG. 12 is a perspective view showing the cutting tooth of FIG. 8 and two additional cutting teeth of differing sizes.

FIG. 13 is a bottom view showing the three cutting teeth of FIG. 12 mounted on the tooth base.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

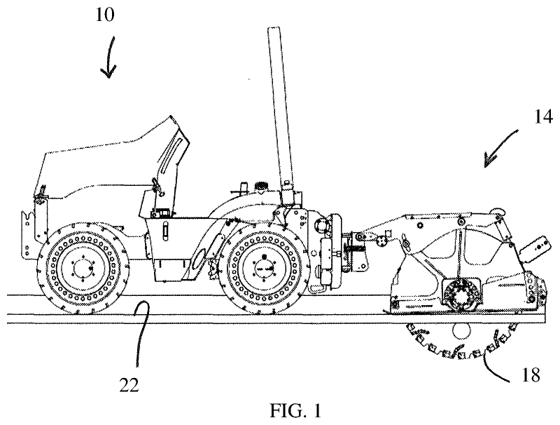

FIG. 1 illustrates a vehicle 10 (e.g., a tractor) towing a rotary cutting assembly 14. The illustrated cutting assembly 14 is of the type commonly used to cut grooves or micro-trenches in concrete or other surfaces. It includes a cutting wheel 18 that can be rotatably driven to cut through or into a work surface 22 (e.g., concrete). In other embodiments, the rotary cutting assembly 14 can be used in different applications. Additionally, while the illustrated cutting assembly 14 is sized and configured to be towed behind a vehicle 10, the invention also applies equally to self-contained, walk-behind cutting assemblies, as well as stationary cutting assemblies.

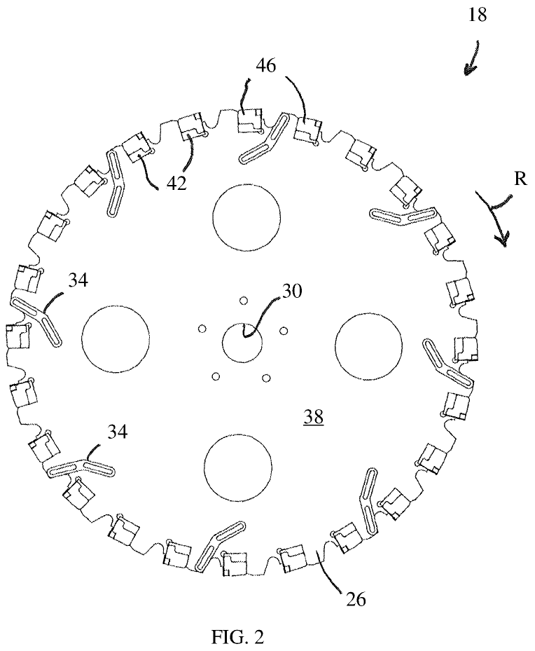

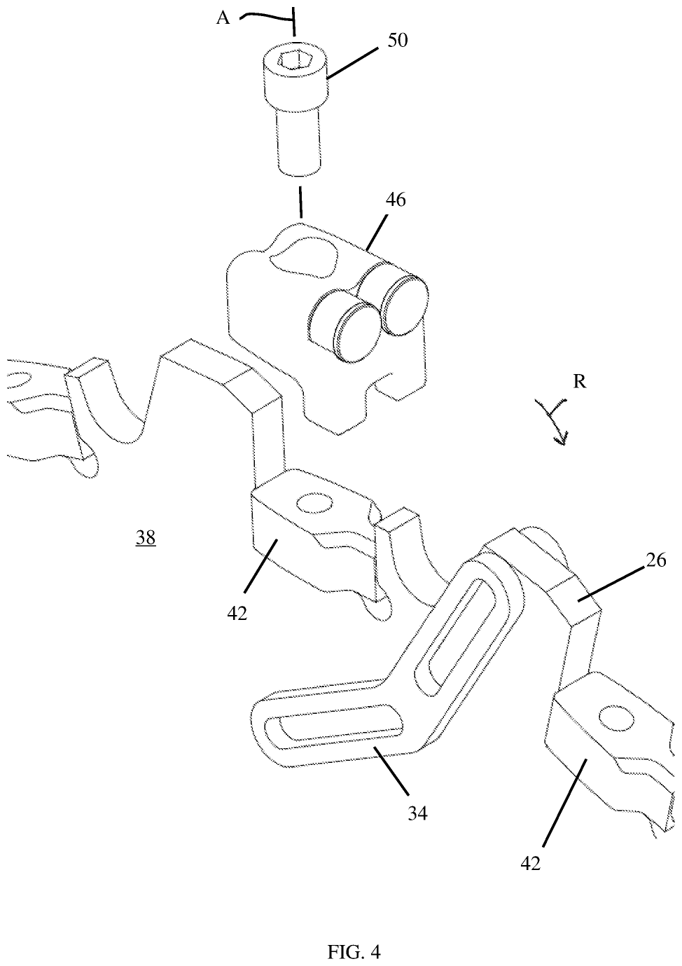

FIGS. 2-4 better illustrate the cutting wheel 18. The cutting wheel 18 is an assembly that includes a wheel or disc 26 having a central mounting aperture 30 (see FIG. 2), and optional wear bars 34 coupled to radially-extending faces 38 of the wheel 26 to prevent wear on the those faces 38. The cutting wheel 18 further includes a plurality of tooth bases or mounts 42 coupled to an outer periphery of the wheel 26 about its circumference. Cutting teeth 46 are removably coupled to each of the respective tooth bases 42 via a single fastener 50 (see FIG. 4) and provide the cutting features of the cutting wheel 18 that operate to cut the groove or trench in the work surface 22 upon rotation of the cutting wheel 18.

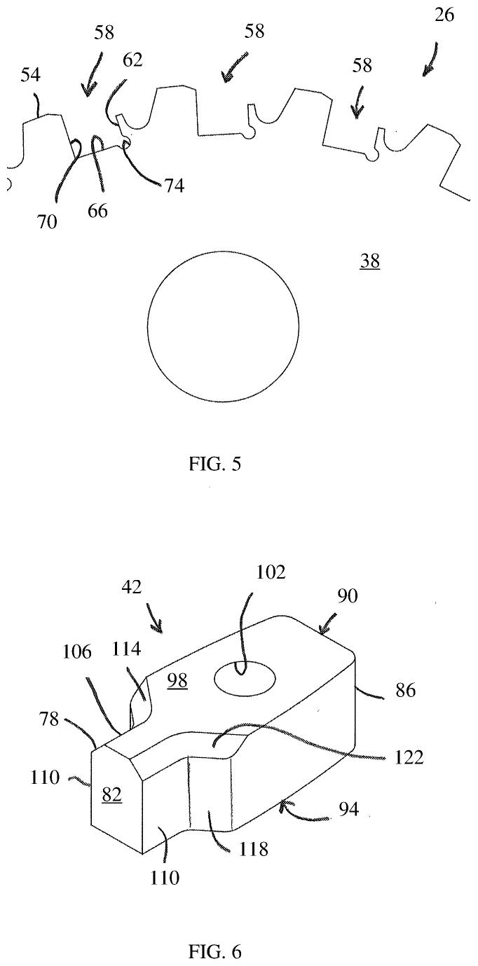

FIG. 5 illustrates a portion of the wheel 26 prior to installation of the tooth bases 42. The wheel 26 includes an outer peripheral surface 54 that has a plurality of recesses 58 sized and configured to receive the tooth bases 42. Each recess 58 includes a first or front wall 62, a second or base wall 66, and a third or rear wall 70. An undercut 74 can be provided at the intersection of the base wall 66 and the front wall 62. In the illustrated embodiment, the bases 42 are welded, brazed, or otherwise secured into the recesses 58 of the wheel 26, as best shown in FIG. 4. The undercut 74 can facilitate welding and may reduce stress on the wheel 26. In other embodiments, the tooth bases 42 can be integrally formed with the wheel 26 instead of being separate parts. The wheel 26 can be made of steel or other suitable metals.

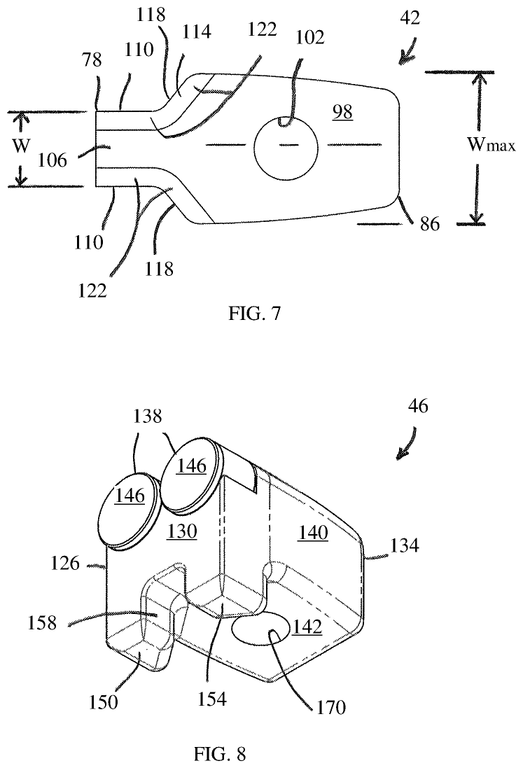

Referring now to FIGS. 6 and 7, each tooth base 42 has a first end 78 with a first end surface 82 configured to abut the front wall 62 of the recess 58, a second end 86 with a second end surface 90 configured to abut the rear wall 70 of the recess 58, and a bottom surface 94 extending between the first and second ends 78, 86 and configured to abut the base wall 66 of the recess 58. Each tooth base 42 also includes an upper surface 98 extending between the first and second ends 78, 86 and configured to at least partially support a cutting tooth 46 thereon, as will be described further below. An aperture, and preferably a threaded blind aperture 102, is formed in the upper surface 98 for receiving the fastener 50 to removably secure the cutting tooth 46 to the tooth base 42, and thereby to the wheel 26.

As best shown in FIG. 7, the tooth base 42 varies in width between the first and second ends 78, 86, and has a narrowed stem or narrowed portion 106, which in the illustrated embodiment, is at the first end 78 of the base 42. The narrowed stem 106 includes side walls 110 that extend from the upper surface 98 and that are spaced apart by a width W (see FIG. 7). In the illustrated embodiment, the width W ranges from 0.25 inches to 0.75 times an overall width of the cutting tooth 46, and the side walls 110 are generally parallel to one another. In one embodiment, the width is 0.5 inches, which is also the width or thickness of the wheel 26. Making the width W match the thickness of the wheel 26 facilitates alignment and welding of the tooth base 42 to the wheel 26. A transition portion 114 is coupled with the narrowed stem 106 and widens the base 42 when moving longitudinally toward the second end 86. The transition portion 114 includes transition walls 118. Each transition wall 118 is angled relative to its respective side wall 110 by an angle between 90 degrees and 160 degrees, and in the illustrated embodiment is about 130 degrees. Optionally, the interface or edge between the upper surface 98 and the side walls 110, and the upper surface 98 and the transition walls 118 can be chamfered, radiused, or otherwise broken as shown at 122 to facilitate receipt and installation of the cutting teeth 46 upon the tooth bases 42.

In the illustrated embodiment, the point on the transition wall 118 furthest from the narrowed stem 106 defines the maximum width Wₘₐₓ of the base 42. From that location, the base 42 narrows in a tapered manner toward the second end 86. In the illustrated embodiment, the taper is actually a radius, and that radius can range from six to nine inches (e.g., about 7.5 inches). This taper is believed to reduce friction during cutting, while still maintaining the strength of the cutting wheel 18. The aperture 102 is spaced from the narrowed stem 106 to be in a wider portion of the base 42. In the illustrated embodiment, the aperture 102 is centered relative to a longitudinal axis of the base 42.

Each tooth base 42 is secured (e.g., welded, brazed, or otherwise connected) to the wheel 26 in the recesses 58 as shown in FIG. 4, such that bottom surface 94 is generally centered upon the base wall 66 of the wheel 26 so that substantially equal amounts of the base 42 overhang or extend outwardly from the oppositely-facing surfaces 38 of the wheel 26. In that manner, the aperture 102 is substantially centered or aligned laterally on the base wall 66. The bases 42 can be made of steel or other suitable metals.

Referring now to FIGS. 8-11, each cutting tooth 46 can be made of steel or other suitable metals and has a first end 126 with a first end surface 130, a second end 134 with a second end surface 138, and a bottom or mounting surface 142 extending between the first and second ends 126, 134 and configured to abut the upper surface 98 of a respective tooth base 42. The illustrated tooth 46 tapers slightly, from wider at the first end 126 to narrower at the second end 134. In the illustrated embodiment, the taper is actually a radius, and that radius can range from six to nine inches (e.g., about 7.5 inches). This helps to provide some clearance and reduce drag as the tooth 46 cuts through the work surface 22. Tooth side walls 140 extend from the first end 126 to the second end 134 and are configured to provide the taper. The illustrated first end surface 130 is initially formed with a pocket or recess for receiving one or more cutting tip inserts 138, which in the illustrated embodiment are polycrystalline diamond cutting (PDC) inserts. In other embodiments, and with other types of cutting teeth, the cutting tip inserts could be made of other wear-resistant materials (e.g., carbides). The cutting tip inserts 138 can be brazed, welded, or otherwise secured to the body material of the tooth 46.

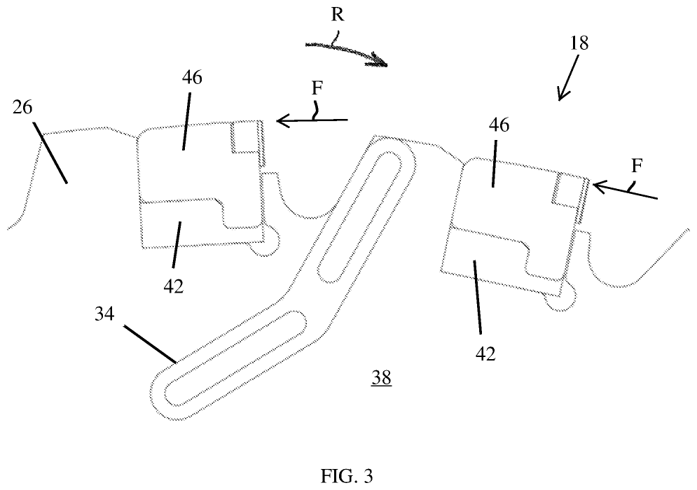

As best shown in FIGS. 10 and 11, the cutting tip inserts 138 have leading cutting surfaces 146 that extend forwardly of or stand proud of the first end surface 130 of the tooth 46 such that the cutting tip inserts 138 define the leading cutting edge of the tooth 46 as the cutting wheel 18 rotates in the cutting direction designated by the arrow R (see FIGS. 2-4). As shown in FIGS. 3 and 10, a dominant force vector F is defined at the radially-outward point on the leading cutting surfaces 146 or the cutting tips. The dominant force vector F is tangential to the generally circular rotation of the cutting wheel 18 and thus perpendicular to a plane containing the leading cutting surfaces 146. In some other embodiments, the cutting plane defined by the leading cutting surfaces 146 may be angled relative to the dominant force vector F such that the cutting plane is angled either forward in the direction of travel of the cutter (i.e. the cutter has a positive rake angle) or rearward in the direction of travel of the cutter (i.e., the cutter has a negative rake angle). In the illustrated embodiment, the mounting surface 142 defines and lies in a plane that is generally parallel to the dominant force vector F at the cutting tip as the cutting wheel 18 cuts through the material of the work surface 22. Furthermore, the fastener 50 includes an axis A (see FIG. 3) generally perpendicular to the dominant force vector F at the cutting tip as the cutting wheel 18 cuts through the material of the work surface 22.

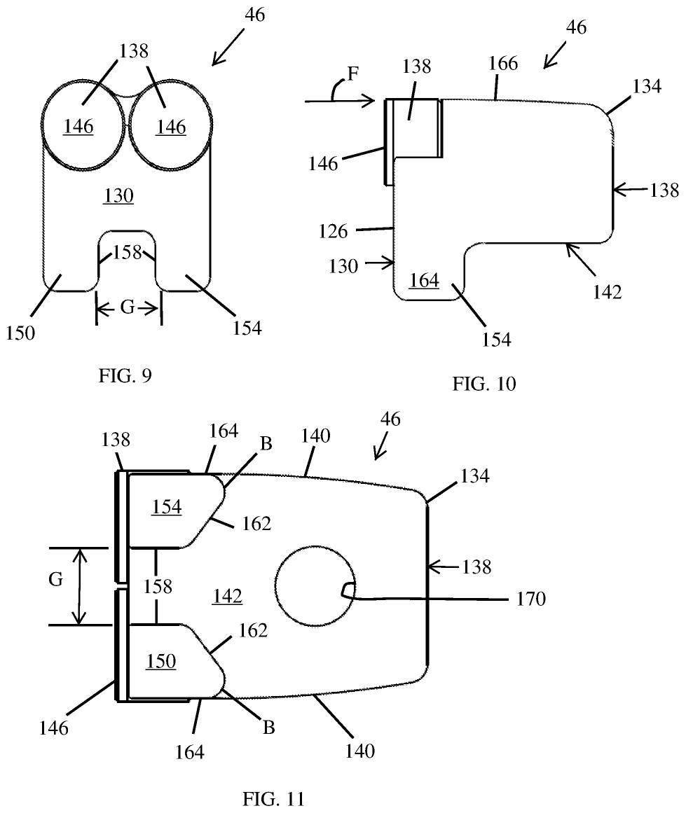

Each cutting tooth 46 further includes first and second projections or bosses 150, 154 adjacent the first end 126 of the tooth 46 and extending from the mounting surface 142 in a direction away from the cutting tip inserts 138 (i.e., downwardly in FIGS. 9 and 10). In other embodiments, the bosses 150, 154 could be spaced from the first end surface 130 rather than being co-planar extensions of the first end surface 130 as illustrated. The bosses 150, 154 are spaced apart from one another by a distance or gap G (see FIGS. 9 and 11) that is at least as large as the width W of the narrowed stem 106, such that the first and second bosses 150, 154 straddle the stem 106 when the mounting surface 142 engages the upper surface 98 of the tooth base 42 on which it is mounted. In other words, one of the bosses 150 is positioned on one side of the narrowed stem 106, and the other boss 154 is positioned on the other side of the narrowed stem 106 when the mounting surface 142 engages the upper surface 98 of the tooth base 42 on which it is mounted. This means that the narrowed stem 106 is at least partially between the two bosses 150, 154. The mounting surface 142 therefore also extends between the bosses 150, 154 such that the mounting surface 142 and the bosses 150, 154 cooperate to define a channel extending between the bosses 150, 154. The channel is sized and configured to receive the narrowed stem 106.

As best shown in FIG. 11, each boss 150, 154 includes reaction surfaces in the form of an inner surface 158 engaging a respective side wall 110 of the narrowed stem 106, and a transition surface 162 engaging a respective transition wall 118 of the transition portion 114, where the tooth base 42 narrows to the narrowed stem 106. The transition surfaces 162 can blend into boss side walls 164 that, in the illustrated embodiment, blend into the tooth side walls 140. A radiused blend B can transition the transition surface 162 to the boss side wall 164. In other embodiments, a chamfered edge or sharper edge may be formed at the intersection of the transition surface 162 and the boss side wall 164. The chamfered, radiused, or otherwise broken edges 122 along the upper surface 98 of the base 42 facilitate installation of the cutting tooth 46 onto the upper surface 98 of the tooth base 42.

In the illustrated embodiment, the inner surface 158 and the transition surface 162 on each boss 150, 154 intersect one another at an angle ranging from 90 degrees to 160 degrees, and in the illustrated embodiment, at an angle of about 130 degrees, which is approximately the same angle, within a tolerance level (e.g. within 5 degrees), between the corresponding transition wall 118 and respective side wall 110 of the base 42. The intersection can be radiused to eliminate sharp edges. This configuration enables the tooth 46 to nest with the narrowed stem 106 and the transition portion 114 of the base 42. In the illustrated embodiment, the inner surfaces 158 of the first and second bosses 150, 154 are generally parallel to one another and are generally perpendicular to the mounting surface 142. As used herein an in the appended claims, the terms generally, substantially, or about, when used to describe angles, parallel surfaces, or perpendicular surfaces, contemplate acceptable tolerance levels in the industry (e.g., within 5 degrees).

The inner surfaces 158 are spaced apart from one another by the distance or gap G (see FIGS. 9 and 11) that is at least as large as the width W of the narrowed stem 106. In the illustrated embodiment, the distance between the inner surfaces 158 of the first and second bosses 150, 154 ranges from 0.25 inches to 0.75 times an overall width of the cutting tooth 46, in correlation with the width W of the narrowed stem 106. For example, where the width W is 0.5 inches, the gap G can be 0.52 inches (and standard manufacturing tolerancing can be used).

A force-transfer interface is defined by the reaction surface sections, which are the inner surfaces 158 and the transition surfaces 162 of the bosses 150, 154 and the corresponding side walls 110 and transition walls 118 of the tooth base 42. That is, in response to a force acting on the cutting tooth 46, one or more of the reaction surface sections transfer the force to the base 42, and ultimately to the wheel 26. The reaction surface sections define planes that are oriented vertically when the cutting tooth 46 first engages the work surface 22 during operation. The complementary surfaces of the cutting tooth 46 and the tooth base 42 facilitate effective transfer of the forces acting on the cutter even with minor differences in manufacturing tolerances between the surfaces, and even when the force is not completely parallel to the mounting surface 142. Stated another way, the reaction surfaces of the cutting tooth 46 and the tooth base 42 cooperate to minimize any moment imparted on the cutting tooth 46 during operation that may tend to dislodge the tooth 46 from the tooth base 42. The reaction surfaces also operate to reduce shear force transferred to the fastener 50, instead transferring all or most of the force from the tooth 46 directly into the tooth base 42. This can be facilitated by selectively tolerancing the parts so that the tolerances at the reaction surfaces are tighter than the tolerances between the fastener 50 and the apertures 102, 170.

Each tooth 46 also includes an upper surface 166 (see FIG. 10) extending between the first and second ends 126, 134. An aperture, and preferably a counter-bored through aperture 170, extends from the upper surface 166 to the mounting surface 142 for receiving the fastener 50 to removably secure the cutting tooth 46 to the tooth base 42, and thereby to the wheel 26. The head of the fastener 50 can be fully recessed in the counter-bore portion of the aperture 170 in the tooth 46. The aperture 170 is spaced from the first end surface 130 and from the bosses 150 154 (i.e., offset from the bosses 150, 154 so as not to intersect the bosses 150, 154), so as to be aligned with the aperture 102 in the base 42 when the tooth 46 is installed on the base 42. The fastener 50 is installed into the aperture 170 in the tooth 46 and extends into the threaded aperture 102 in the base 42. The fastener 50 is torqued tight to secure the tooth 46 onto the base 42. By using a fastener 50, the cutting teeth 46 can be removed and replaced when the cutting tips 138 become worn. The use of only a single fastener 50 for each tooth 46 reduces the time and effort needed to replace the teeth 46. The use of a single fastener 50 is facilitated, in part, by the above-described configuration of the base 42 and the tooth 46, and by the reaction surfaces provided on those components.

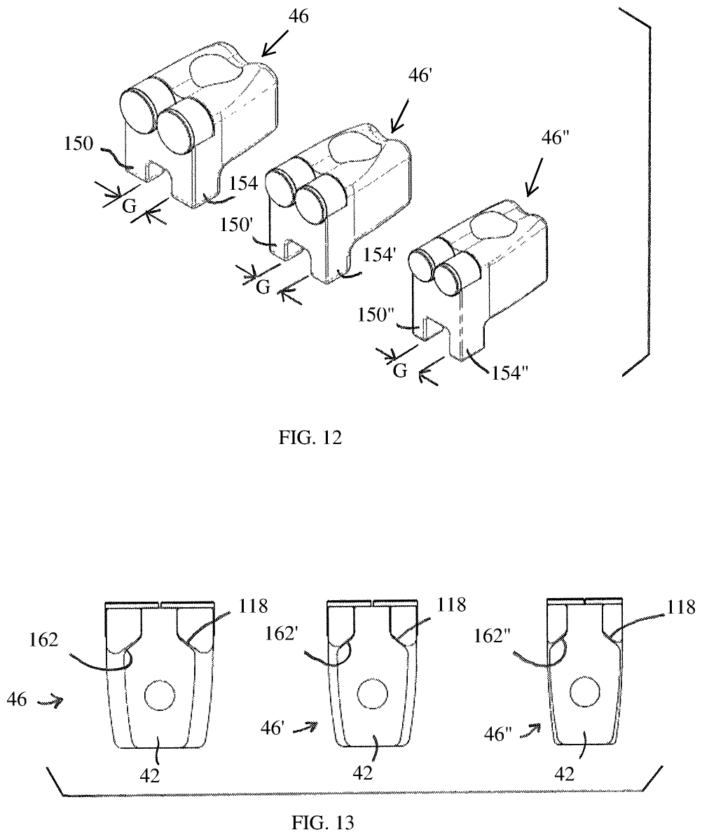

FIG. 12 illustrates three differently sized cutting teeth 46, 46′ and 46″ for use in different applications (i.e., to cut micro-trenches of differing widths). Despite their differing sizes, all three illustrated teeth are configured to be mounted onto the same tooth base 42. This is achieved due to the consistent geometry aspects of the bosses 150, 154, 150′, 154′, and 150″, 154″, such as the consistent gap G and the generally consistent reaction surfaces. FIG. 13 illustrates the three teeth 46, 46′ and 46″ mounted on the tooth base 42. It can be seen that the interface between the transitions surfaces 162, 162′, and 162″ and the transition wall 118 of the tooth base 42 varies slightly from tooth to tooth. This is caused by variations in the transition surfaces 162, 162′, 162″ of the different teeth 46, 46′ and 46″ occurring due to manufacturing, tolerancing, and other geometrical limitations associated with the differing sizes. As seen in FIG. 13, the fit between the transitions surfaces 162, 162′, 162″ and the transition wall 118 can deviate somewhat (e.g., up to about 5 degrees) in either direction from a parallel surface engagement. While this may impact the contact patch/engagement location between the surfaces, the reaction surfaces still operate to hold the teeth 46, 46′, and 46″ in place on the base 42 and to transfer force imparted on the teeth 46, 46′, and 46″ into the base 42.

Various features of the invention are set forth in the following claims.

What is claimed is:

1. A rotating cutting assembly comprising:
a wheel;
a tooth base coupled to an outer periphery of the wheel, the tooth base including a narrowed stem and an aperture spaced from the narrowed stem;
a cutting tooth removably secured to the tooth base, the cutting tooth having a mounting surface configured to engage the tooth base, and first and second bosses extending from the mounting surface and spaced apart from one another by a distance at least as large as a width of the narrowed stem such that the first and second bosses straddle the stem when the mounting surface engages the tooth base, the cutting tooth further including an aperture aligned with the aperture in the tooth base; and
a fastener received in the aperture of the cutting tooth and the aperture of the tooth base to removably secure the cutting tooth to the tooth base.

2. The rotating cutting assembly of claim 1, wherein the narrowed stem is adjacent an end of the tooth base and wherein the first and second bosses are adjacent an end of the cutting tooth.

3. The rotating cutting assembly of claim 1, wherein the cutting tooth includes a cutting tip made of a wear-resistant material.

4. The rotating cutting assembly of claim 3, wherein the cutting tip is a polycrystalline diamond cutting (PDC) insert.

5. The rotating cutting assembly of claim 3, wherein the fastener defines an axis generally perpendicular to a dominant force vector at the cutting tip as the cutting assembly cuts through a material.

6. The rotating cutting assembly of claim 3, wherein the mounting surface defines a plane that is generally parallel to a dominant force vector at the cutting tip as the cutting assembly cuts through a material.

7. The rotating cutting assembly of claim 1, wherein each of the first and second bosses includes an inner surface engaging a respective side wall of the narrowed stem, and a transition surface engaging a respective transition wall where the tooth base narrows to the narrowed stem.

8. The rotating cutting assembly of claim 7, wherein the inner surface and the transition surface intersect one another at an angle ranging from 90 degrees to 160 degrees.

9. The rotating cutting assembly of claim 7, wherein the inner surfaces of the first and second bosses are generally parallel to one another and generally perpendicular to the mounting surface.

10. The rotating cutting assembly of claim 9, wherein the inner surfaces of the first and second bosses are spaced apart from one another by a distance larger than a distance between the respective side walls of the narrowed stem.

11. The rotating cutting assembly of claim 10, wherein the distance between the inner surfaces of the first and second bosses ranges from 0.25 inches to 0.75 times an overall width of the cutting tooth.

12. The rotating cutting assembly of claim 1, wherein the tooth base is welded to the wheel.

13. The rotating cutting assembly of claim 1, wherein the tooth base is integrally formed with the wheel.

14. The rotating cutting assembly of claim 1, wherein the wheel includes a recess formed on its outer periphery, the tooth base being secured to the wheel in the recess.

15. The rotating cutting assembly of claim 1, wherein the narrowed stem includes chamfered, radiused, or otherwise broken edges that facilitate installation of the cutting tooth onto the tooth base.

16. A cutting tooth configured to be mounted on a rotating apparatus, the cutting tooth comprising:
a body having
a mounting surface configured to engage the rotating apparatus,
first and second bosses extending from the mounting surface and spaced apart from one another such that a portion of the rotating apparatus can be positioned between the first and second bosses when the mounting surface engages the rotating apparatus, and
an aperture configured to receive a fastener for removably securing the cutting tooth to the rotating apparatus; and
a cutting tip coupled to the body.

17. The cutting tooth of claim 16, wherein the cutting tip is a polycrystalline diamond cutting (PDC) insert.

18. The cutting tooth of claim 16, wherein each of the first and second bosses includes an inner surface and a transition surface intersecting one another at an angle ranging from 90 degrees to 160 degrees.

19. The cutting tooth of claim 18, wherein the angle is about 130 degrees.

20. The cutting tooth of claim 18, wherein the inner surfaces of the first and second bosses are generally parallel to one another and generally perpendicular to the mounting surface.

21. A rotating cutting assembly comprising:
a wheel;
a tooth base coupled to an outer periphery of the wheel, the tooth base including a narrowed portion having an upper surface, spaced-apart side walls extending from the upper surface, and an aperture spaced from the narrowed portion;
a cutting tooth removably secured to the tooth base, the cutting tooth having a mounting surface configured to engage the upper surface of the tooth base, and first and second bosses extending from the mounting surface and spaced apart from one another such that respective inner surfaces of the first and second bosses engage the respective side walls of the narrowed portion when the mounting surface engages the upper surface, the cutting tooth further including an aperture aligned with the aperture in the tooth base; and
a fastener received in the aperture of the cutting tooth and the aperture of the tooth base to removably secure the cutting tooth to the tooth base;
wherein the fastener includes an axis generally perpendicular to a dominant force vector at a cutting tip of the cutting tooth as the cutting assembly cuts through a material;
wherein the mounting surface defines a plane that is generally parallel to the dominant force vector at the cutting tip; and
wherein the inner surfaces of the first and second bosses are generally parallel to one another and generally perpendicular to the mounting surface.
